(19) United States
(12) Patent Application Publication
(10) Pub. No.: US 2014/0084008 A1
(43) Pub. Date: Mar. 27, 2014

(54) WASTE BIN

(71) Applicant: Derek Conway, Rochester, NY (US)

(72) Inventor: Derek Conway, Rochester, NY (US)

(21) Appl. No.: 14/033,823

(22) Filed: Sep. 23, 2013

Related U.S. Application Data
(60) Provisional application No. 61/705,234, filed on Sep. 25, 2012.

(51) Int. Cl. B65F 1/06; B65F 1/14

(52) U.S. Cl. CPC B65F 1/06; B65F 1/14
USPC 220/495.04

(57) ABSTRACT

Disclosed in this specification is a waste bin with an electric fan for removing air from the receptacle. The electric fan is disposed at a predetermined distance from the bottom surface of the receptacle. Upon activation of the electric fan, the electric fan remains on for a predetermined period of time and thereafter automatically turns off. While the fan is active, a bag can more easily be disposed within the receptacle.

### CROSS-REFERENCE TO RELATED APPLICATION

This application claims priority to U.S. patent application Ser. No. 61/705,234 (filed Sep. 25, 2012), the entirety of which is incorporated herein by reference.

### FIELD OF THE INVENTION

This invention relates, in one embodiment, to a waste bin with an electric fan to remove air from the space within the receptacle. This facilitates the placement of a bag within the receptacle.

### BACKGROUND

Waste bins are widely used in residential households and commercial facilities. Flexible plastic bags are placed in the opening of traditional waste bins. Many users have difficulty properly positioning the bags within traditional waste bins—the bags often adhere to the sides of the bin and fail to reach the bottom. Additionally, as the bags are filled with waste, the bags tend to establish a seal with the waste bin which makes removal of the bag difficult.

Therefore, an improved waste bin is desired that addresses at least some of these shortcomings.

### SUMMARY OF THE INVENTION

Disclosed in this specification is a waste bin with an electric fan for removing air from the receptacle. The electric fan is disposed at a predetermined distance from the bottom surface of the receptacle. Upon activation of the electric fan, the electric fan remains on for a predetermined period of time and thereafter automatically turns off. While the fan is active, a bag can more easily be disposed within the receptacle.

In one exemplary embodiment, a waste bin for permitting easy manipulation of a bag, the waste bin is disclosed. The waste bin comprises a receptacle with a bottom surface, an opening and at least one vertical surface surrounding the bottom surface and the opening to define a space within the receptacle; an electric fan disposed in the vertical surface of the receptacle that provides an air pathway between the space within the receptacle and an ambient environment, the electric fan being disposed at a predetermined distance from the bottom surface; an electrical circuit connected to the electric fan to control operation of the electric fan; and an actuation switch in communication with the electrical circuit for activating the electric fan.

In another exemplary embodiment, a method for disposing a bag within a waste bin is disposed. The method comprising the steps of: disposing a bag proximate an opening of a receptacle, the receptacle having: a bottom surface, the opening and at least one vertical surface surrounding the bottom surface and the opening to define a space within the receptacle; an electric fan disposed in the vertical surface of the receptacle that provides an air pathway between the space within the receptacle and an ambient environment, the electric fan being disposed at a predetermined distance from the bottom surface; an electrical circuit connected to the electric fan to control operation of the electric fan; and an actuation switch in communication with the electrical circuit for activating the electric fan. The method further comprises the steps of activating the actuation switch to cause the electric fan to turn on; permitting the electric fan to pull the bag toward the bottom surface of the receptacle; and permitting the electrical circuit to turn the electric fan off after a predetermined period of time.

In yet another exemplary embodiment, a system for disposing a bag within a waste bin is disclosed. The system comprising an adaptor comprising an elongated pipe with a top opening and a bottom opening at opposite ends of the elongated pipe. The adapter further includes: an electric fan in the elongated pipe for moving air into the bottom opening and out of the top opening; an electrical circuit connected to the electric fan to control operation of the electric fan; an actuation switch in communication with the electrical circuit for activating the electric fan. The system further comprises a receptacle with a bottom surface, an opening and at least one vertical surface surrounding the bottom surface and the opening to define a space within the receptacle. The adaptor is disposed at least partially within the space within the receptacle such that the bottom opening is proximate the bottom surface of the receptacle and the top opening is proximate the opening.

### BRIEF DESCRIPTION OF THE DRAWINGS

The present invention is disclosed with reference to the accompanying drawings, wherein:

FIG. 1 is a schematic depiction of an exemplary waste bin;

FIG. 2 is an enlarged view of an exemplary electric fan;

FIG. 3A and FIG. 3B are cross-sectional views of an exemplary receptacle;

FIG. 4 is a flow diagram of an exemplary method for controlling an actuation switch;

FIG. 5 is a depiction of an exemplary lid showing an actuation switch;

FIG. 6A and FIG. 6B illustrate a protective screen over the electric fan; and

FIG. 7A and FIG. 7B depict an exemplary adapter.

Corresponding reference characters indicate corresponding parts throughout the several views. The examples set out herein illustrate several embodiments of the invention but should not be construed as limiting the scope of the invention in any manner.

### DETAILED DESCRIPTION

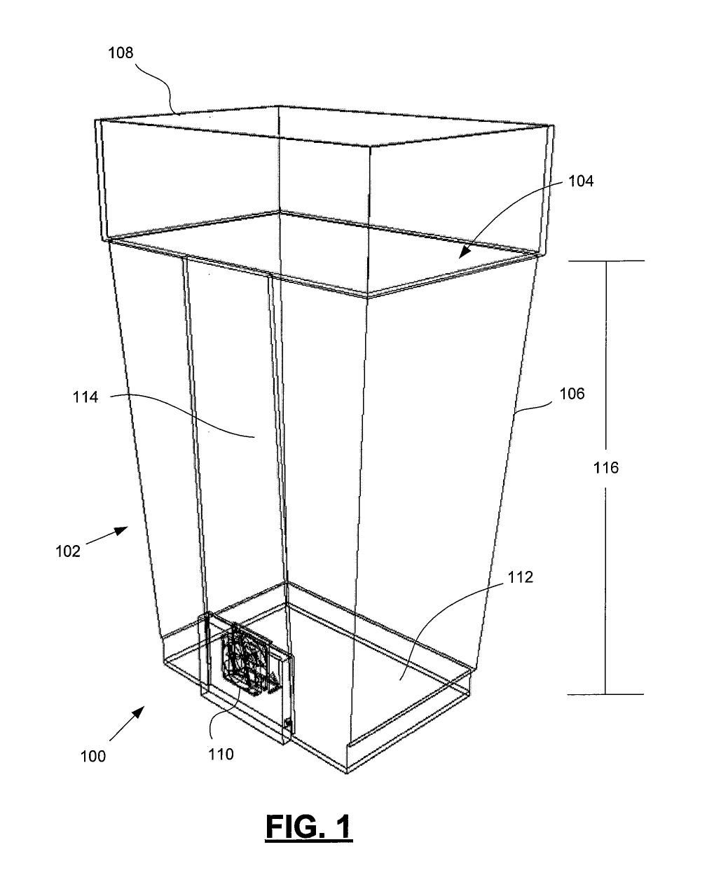

FIG. 1 is a schematic depiction of an exemplary waste bin 100. The waste bin 100 comprises a receptacle 102 with an opening 104 surrounded by vertical surfaces 106. The exemplary waste bin 100 has four vertical surfaces 106 which provide a rectangular opening 104. In other embodiments, there may be a different number of vertical surfaces 106 to provide openings 104 of various shapes including squares, circles, ovals, and other shapes. The receptacle 102 may be formed from any suitable material, including metal and/or plastic. In the embodiment depicted in FIG. 1, the waste bin 100 further comprises a lid 108 shaped to fit the opening 104. Lid 108 may fit to the opening 104 with a secure connector. Examples of secure connectors include snap connectors, hinge connectors and the like. The receptacle 102 comprises an electric fan 110 in vertical surface 106. The electric fan 110 is proximate a bottom surface 112. The electric fan 110 provides a pathway between the space 114 within receptacle 102 and the ambient environment. In one embodiment, the electric fan 110 is disposed in the lower 50% of the height 116 of the receptacle 102. In another embodiment, the electric fan 110 is disposed in the lower 25% of the height 116 of the receptacle 102. In yet another embodiment, the electric fan 110 is disposed in the lower 10% of the height 116 of the receptacle 102.

In use, a user disposes a flexible bag near opening 104. The electric fan 110 is then activated. The electric fan 110 moves air from space 114 which pulls the bag toward bottom surface 112. In this fashion the bag is properly and easily deployed within the waste bin 100. When the user wishes to remove the bag from the waste bin 100, the electric fan 110 provides a pathway to supply air into the space 114 from the ambient environment. As the bag is lifted, air passes from the ambient environment, around the blades of the electric fan 110, and into the space 114. This prevents the formation of a vacuum within the space 114 thereby facilitating removal of the bag. The electric fan 110 need not be on while the bag is removed. As a further advantage, the user can place the bag in the receptacle 102 with minimal contact with the bag. This is particularly advantageous in situations where hygiene is a concern such as, for example, in health care environments.

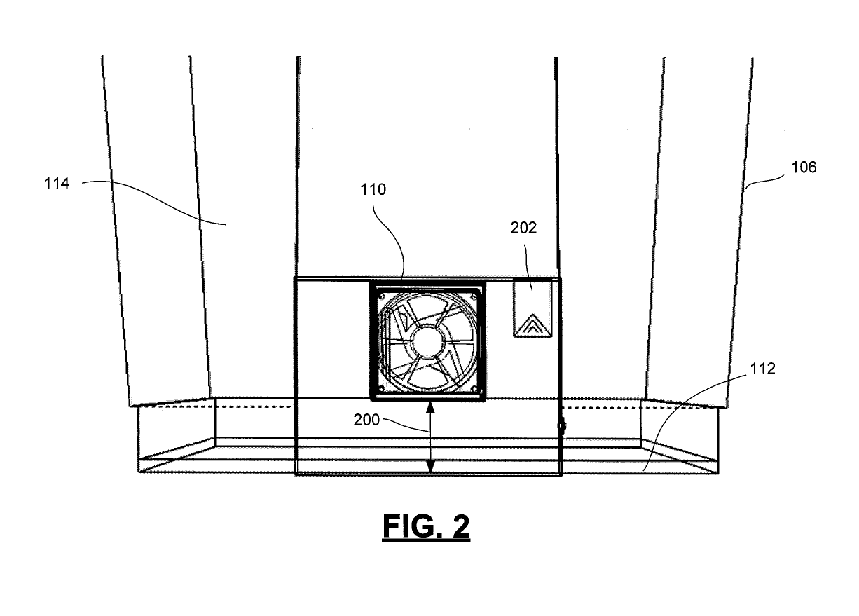

FIG. 2 is an enlarged view of the electric fan 110. The electric fan 110 is placed a predetermined distance 200 from the bottom surface 112. The predetermined distance 200 is greater than zero centimeters. Advantageously, this prevents contamination of the electric fan 110. For example, if liquid waste escapes the bag, the liquid pools near the bottom surface 112. However, due to the predetermined distance 200, this liquid does not contact the electric fan 110 and the functioning of the electric fan 110 is not hindered. In one embodiment, the predetermined distance is between one centimeter and ten centimeters. In another embodiment, the predetermined distance is between two centimeters and eight centimeters. In yet another embodiment, the predetermined distance is between three centimeters and eight centimeters.

Referring again to FIG. 2, the electric fan 110 is coupled to electrical circuit 202. The electrical circuit 202 may further include a power supply that powers the fan (e.g. a battery or adapter that connects to an electric plug). The electrical circuit 202 controls the operation of the electric fan 110. The electric fan 110 may be, for example a nine to twenty-four volt electric fan. In another embodiment, the electric fan 110 is a nine to twelve volt electric fan.

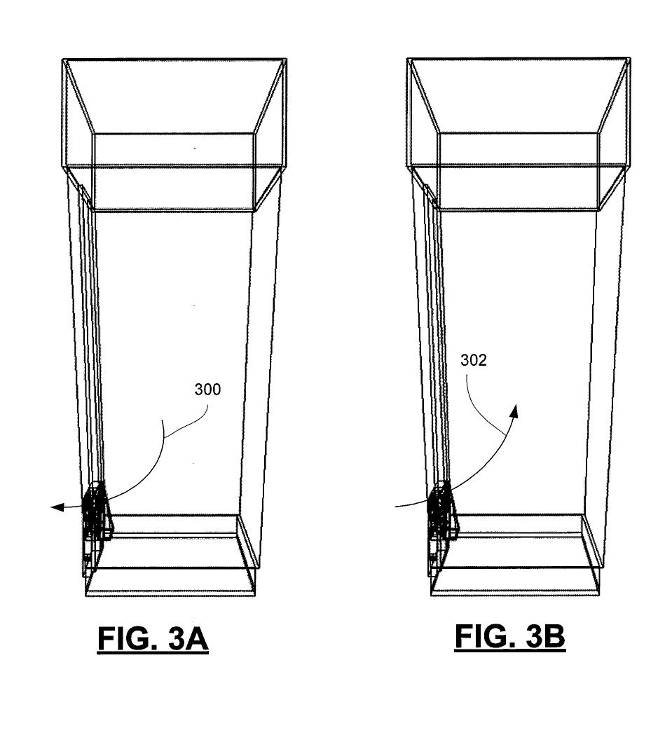

The electric fan 110 has blades with a handedness configured to remove air from the space 114 when the electric fan 110 is actuated. In one embodiment, the electric fan 110 is freely rotating such that, when the electric fan 110 is not actuated, it can rotate in a direction opposite its handedness. As shown in FIG. 3A and FIG. 3B, this permits the electric fan 110 to rotate in a reverse direction when the bag is removed. For example, the electric fan may be configured to actively rotate in a first rotary direction upon actuation and this rotation moves air from the space 114 in the direction of arrow 300. The electric fan 110 may also passively rotate in a second rotary direction, opposite the first rotary direction, when the electric fan 110 is not actuated by virtue of the motion of air passing around the blades as the air moves from the ambient environment, in the direction of arrow 302, into the space 14. In another embodiment, the actuation switch includes a directional control for reversing the rotary direction of the electric fan 110. Such an embodiment actively supplies air into the space 114.

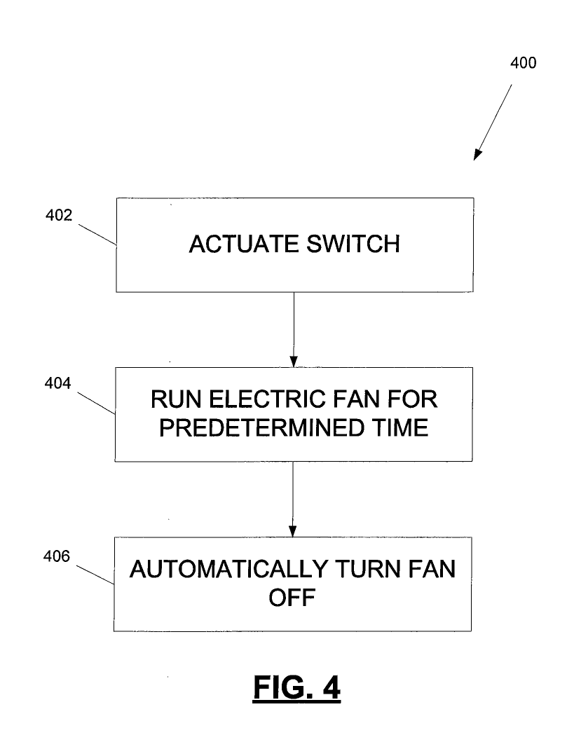

FIG. 4 is a flow diagram of an exemplary method 400 for controlling an actuation switch. Method 400 begins with step 402 wherein an actuation switch is activated which, in turn, actuates the electric fan 110. In one embodiment, the actuation switch is a manual switch. Such a manual switch may be located, for example, proximate the opening 104. In other embodiments, the actuation switch may be an automated switch that is connected to a sensor such as a motion sensor or light sensor.

In step 404 of the method 400, the electric fan 110 is run for a predetermined period of time. In one embodiment, the predetermined period of time is preprogrammed into a timing circuit in the electrical circuit 202. In another embodiment, the predetermined period of time is adjustable by virtue of a user-operable controller, such as a dial controller connected to the electrical circuit 202. Examples of suitable predetermined periods of time may be ten seconds to two minutes. In another embodiment, the predetermined period of time is between ten seconds and one minute. In yet another embodiment, the predetermined period of time is between ten seconds and thirty seconds.

In step 406 of the method 400, the electrical circuit 202 automatically turn the electric fan 110 off after the predetermined period of time has elapsed.

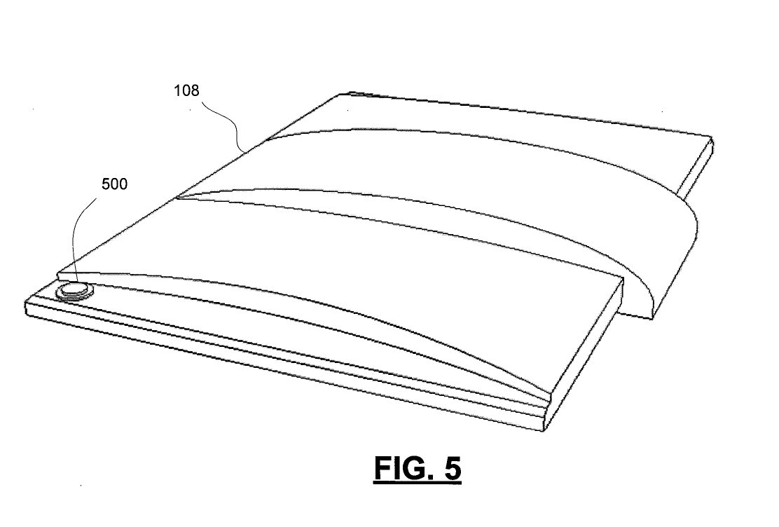

FIG. 5 is a depiction of exemplary lid 108 showing an actuation switch 500. Although the actuation switch 500 is depicted as being disposed in the lid 108, the actuation switch 500 may be placed at alternative locations. For example, in one embodiment, the actuation switch 500 is disposed on the external surface of electric fan 110. In another embodiment, the actuation switch 500 is disposed on the external surface of the receptacle 102 near the bottom surface 114. In one such embodiment, the actuation switch is a foot pedal. The actuation switch 500 is in communication with the electrical circuit 202. In one embodiment, the actuation switch 500 is in communication with the electrical circuit by a wired connection. In another embodiment, the actuation switch 500 is in communication with the electrical circuit by a wireless connection.

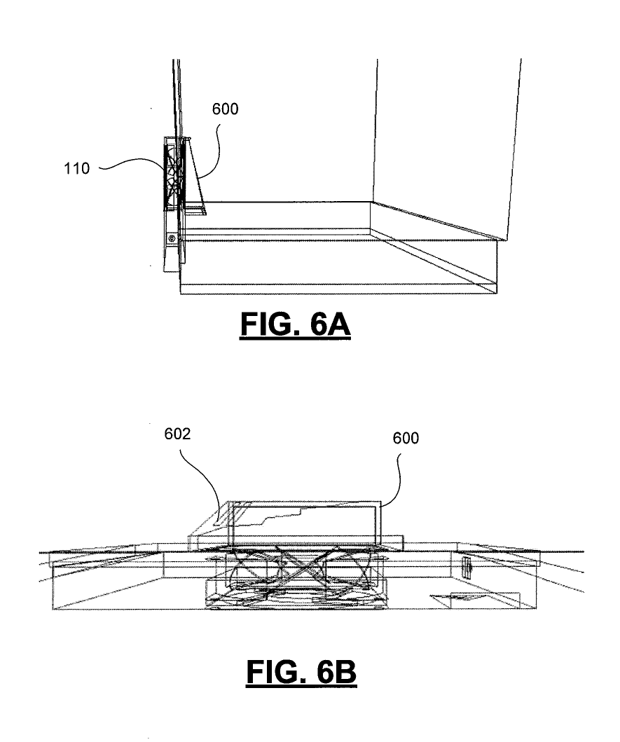

FIG. 6A and FIG. 6B illustrate a protective screen 600 over the electric fan 110. Protective screen 600 faces the space 114 and keeps the bag away from the blades of the electric fan 110. The protective screen 600 has grates 602 to permit air to pass through the protective screen 600. In the embodiment depicted in FIG. 6B, the grates 602 are on the vertical surface of protective screen 600. In other embodiments, the grates may be on a horizontal surface of protective screen 600 (e.g. on the bottom). In yet another embodiment, the grates are on both horizontal or vertical surfaces. In the embodiment of FIG. 6A, the protective screen has an angled vertical surface that slopes outwardly and downwardly away from the electric fan 110. This provides an exposed bottom horizontal surface suitable for grates.

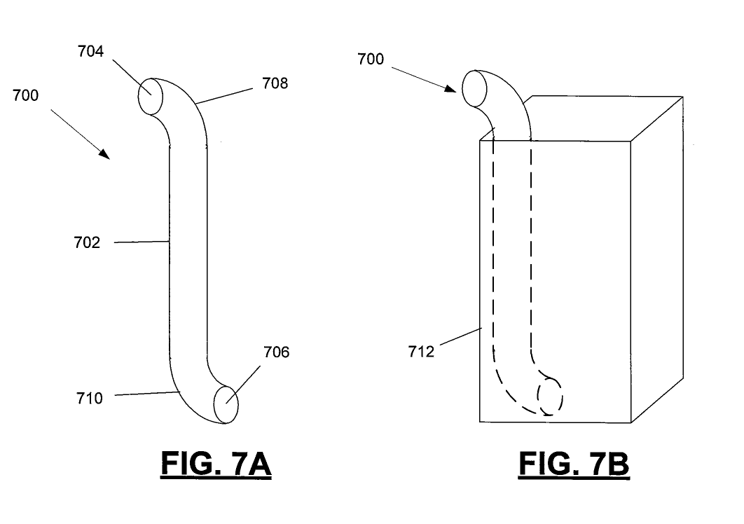

FIG. 7A and FIG. 7B depict an exemplary adapter. FIG. 7A depicts an adaptor 700 that comprises an elongated pipe 702 fitted with a top opening 704 and a bottom opening 706. The adapter 700 permits one to retrofit an existing receptacle 712 (see FIG. 7B). In the exemplary embodiment depicted in FIG. 7A, the top opening 704 is connected to the elongated pipe 702 by a top curvature 708. The adaptor 700 may be attached by simply hanging curvature 708 over the vertical surface of receptacle 712. In another embodiment fasteners, such as clips, are used to secure the adaptor 700 to the receptacle 712. The bottom opening 706 is connected to the elongated pipe 702 by a bottom curvature 710. An electric fan (not shown) is disposed at a point along the adaptor 700. This electric fan is configured in a fashion analogous to the electric fan 110 and is disposed at a predetermined distance from the bottom opening 706. The electric fan may be disposed proximate the top opening 704, proximate the bottom opening 706 or at any point between. It should be understood that FIG. 7A and FIG. 7B are schematic depictions only. The relative dimensions of the components may be altered to fit a particular design. For example, the pipe need not be cylindrical and/or the diameter may be reduced. In those embodiments where a lid is present, the diameter of adapter 700 may be reduced to permit the lid to attach to the receptacle. The adapter 700 also comprises electric circuit and actuation switch (not shown) for controlling the fan. In one embodiment, the actuation switch is proximate the top opening 704 for easy access.

In one embodiment, the adaptor 700 has one or more accordion connectors to permit the adaptor to be flexed to fit a particular receptacle. For example, top curvature 708 and/or bottom curvature 710 may be accordion connectors. Additionally or alternatively, an accordion connector may be present in elongated pipe 702. This permits additional flexibility as well as permits the elongated pipe to be extended lengthwise to accommodate receptacles of various heights. In another embodiment, elongated pipe 702 is fitted with a telescoping connector to permit lengthwise adjustment.

While the invention has been described with reference to certain embodiments, it will be understood by those skilled in the art that various changes may be made and equivalents may be substituted for elements thereof to adapt to particular situations without departing from the scope of the disclosure. Therefore, it is intended that the claims not be limited to the particular embodiments disclosed, but that the claims will include all embodiments falling within the scope and spirit of the appended claims.

What is claimed is:

1. A waste bin for permitting easy manipulation of a bag, the waste bin comprising:
a receptacle with a bottom surface, an opening and at least one vertical surface surrounding the bottom surface and the opening to define a space within the receptacle;
an electric fan disposed in the vertical surface of the receptacle that provides an air pathway between the space within the receptacle and an ambient environment, the electric fan being disposed at a predetermined distance from the bottom surface;
an electrical circuit connected to the electric fan to control operation of the electric fan; and
an actuation switch in communication with the electrical circuit for activating the electric fan.

2. The waste bin as recited in claim 1, wherein the electrical circuit rotates the blades in a first rotary direction when the electric fan is activated, the first rotary direction moving air from the space within the receptacle to the ambient environment.

3. The waste bin as recited in claim 2, wherein the electric fan is freely rotating such that it can rotate in a second rotary direction, opposite the first rotary direction, when the electric fan is not activated.

4. The waste bin as recited in claim 1, wherein the electrical circuit comprises a timing circuit that actuates the electric fan for a predetermined period of time when the actuation switch is activated and therefore deactivates the electric fan.

5. The waste bin as recited in claim 1, wherein the receptacle has a height and the electric fan is disposed in a lower 50% of the height that is proximate the bottom surface of the receptacle but at least one centimeter above the bottom surface of the receptacle.

6. The waste bin as recited in claim 1, wherein the receptacle has a height and the electric fan is disposed in a lower 25% of the height that is proximate the bottom surface of the receptacle but at least one centimeter above the bottom surface of the receptacle.

7. The waste bin as recited in claim 1, further comprising a protective screen on the electric fan, the protective screen facing the space within the receptacle.

8. The waste bin as recited in claim 1, wherein the actuation switch includes a directional control for reversing the rotary direction of the electric fan.

9. A method for disposing a bag within a waste bin, the method comprising the steps of:
disposing a bag proximate an opening of a receptacle, the receptacle having:
a bottom surface, the opening and at least one vertical surface surrounding the bottom surface and the opening to define a space within the receptacle;
an electric fan disposed in the vertical surface of the receptacle that provides an air pathway between the space within the receptacle and an ambient environment, the electric fan being disposed at a predetermined distance from the bottom surface;
an electrical circuit connected to the electric fan to control operation of the electric fan;
an actuation switch in communication with the electrical circuit for activating the electric fan;
activating the actuation switch to cause the electric fan to turn on;
permitting the electric fan to pull the bag toward the bottom surface of the receptacle; and
permitting the electrical circuit to turn the electric fan off after a predetermined period of time.

10. The method as recited in claim 9, wherein the actuation switch includes a directional control for reversing the rotary direction of the electric fan, the method including the step of activating the direction control and permitting the electric fan to supply air into the space within the receptacle.

11. A system for disposing a bag within a waste bin, the system comprising:
an adaptor comprising an elongated pipe with a top opening and a bottom opening at opposite ends of the elongated pipe, the adapter further including:
an electric fan in the elongated pipe for moving air into the bottom opening and out of the top opening;
an electrical circuit connected to the electric fan to control operation of the electric fan;
an actuation switch in communication with the electrical circuit for activating the electric fan;
a receptacle with a bottom surface, an opening and at least one vertical surface surrounding the bottom surface and the opening to define a space within the receptacle;
wherein the adaptor is disposed at least partially within the space within the receptacle such that the bottom opening is proximate the bottom surface of the receptacle and the top opening is proximate the opening.

12. The system as recited in claim 11, wherein the adaptor further comprises a curvature between the elongated pipe and the top opening.

13. The system as recited in claim 12, wherein the curvature is an accordion connector.

14. The system as recited in claim 13, wherein the adaptor further comprises a second accordion connector in the elongated pipe for extending the length of the elongated pipe.
